(19) United States
(12) Patent Application Publication
(10) Pub. No.: US 2022/0061032 A1
(43) Pub. Date: Feb. 24, 2022

(54) RADIO COMMUNICATION

(71) Applicant: Nordic Semiconductor ASA, Trondheim (NO)

(72) Inventor: Pasi YLIUNTINEN, Trondheim (NO)

(73) Assignee: Nordic Semiconductor ASA, Trondheim (NO)

(21) Appl. No.: 17/413,428

(22) PCT Filed: Dec. 11, 2019
(86) PCT No.: PCT/EP2019/084709

§ 371 Date: Jun. 11, 2021

(30) Foreign Application Priority Data
Dec. 11, 2018 (GB) 1820174.9

(51) Int. Cl. H04W 72/04; H04W 4/70; G16Y 10/75; H04L 1/00; H04W 52/02

(52) U.S. Cl. CPC H04W 72/042; H04W 4/70; H04W 52/0229; H04L 1/0013; G16Y 10/75

(57) ABSTRACT

A method of operating a radio receiver device to monitor a paging group over a paging period. The paging group comprises one or more paging candidates, each having a respective repetition length. The method comprises: receiving one or more data symbols; attempting to decode said received data symbols, wherein a successful decoding attempt produces a decoded message comprising a value indicative of a respective repetition length of said decoded message; and, if the decoding attempt is successful, stopping monitoring of a paging candidate having a respective repetition length greater than said value before the end of the paging period.

### TECHNICAL FIELD

The present invention relates to receiving data packets via a radio communications network, particularly, although not exclusively, a cellular network such as a Long Term Evolution (LTE) network.

### BACKGROUND

In recent years, the Long Term Evolution (LTE) network, a fourth generation (or “4G”) network standard specified by the 3^{rd} Generation Partnership Project (3GPP), has gained popularity due to its relatively high uplink and downlink speeds and larger network capacity compared to earlier 2G and 3G networks. More accurately, LTE is the access part of the Evolved Packet System (EPS), a purely Internet Protocol (IP) based communication technology in which both real-time services (e.g. voice) and data services are carried by the IP protocol. The air interface of LTE is often referred to as Evolved UMTS Terrestrial Radio Access (or “E-UTRA”).

However, while “classic” LTE connections are becoming increasingly prevalent in the telecommunications industry, further developments to the communication standard are being made in order to facilitate the so-called “Internet of Things” (IoT), a common name for the inter-networking of physical devices, sometimes called “smart devices”, providing physical objects that may not have been connected to any network in the past with the ability to communicate with other physical and/or virtual objects. Such smart devices include: vehicles; buildings; household appliances, lighting, and heating (e.g. for home automation); and medical devices.

These smart devices are typically real-world objects with embedded electronics, software, sensors, actuators, and network connectivity, thus allowing them to collect, share, and act upon data. These devices may communicate with user devices (e.g. interfacing with a user's smartphone) and/or with other smart devices, thus providing “machine-to-machine” (or “machine type”) communication (MTC). However, the development of the LTE standards makes it more practical for them to connect directly to the cellular network.

3GPP have specified two versions of LTE for such purposes in Release 13 of the LTE standard. The first of these is called “NarrowBand IoT” (NB-IoT), sometimes referred to as “LTE Cat NB1”, and the second is called “enhanced Machine Type Communication” (eMTC), sometimes referred to as “LTE Cat M1”. It is envisaged that the number of devices that utilise at least one of these standards for IoT purposes will grow dramatically in the near future.

From a communications perspective, LTE standards (including NB-IoT and eMTC) use orthogonal frequency division multiple access (OFDMA) as the basis for allocating network resources. This allows the available bandwidth between to be shared between user equipment (UE) that accesses the network in a given cell, provided by a base station, referred to in LTE as an “enhanced node B”, “eNodeB”, or simply “eNB”. OFDMA is a multi-user variant of orthogonal frequency division multiplexing (OFDM), a multiplexing scheme known in the art per se.

At the physical layer, in the downlink of an LTE connection, each data frame is 10 ms long and is constructed from ten sub-frames, each of 1 ms duration. Each sub-frame contains two slots of equal length, i.e. two 0.5 ms slots. Each slot (and by extension, each sub-frame and each frame) will typically contain a certain number of “resource blocks” (where each sub-frame has twice as many resource-blocks as a slot and each frame has ten times as many resource blocks as a sub-frame). A resource block is 0.5 ms long in the time domain and is twelve sub-carriers wide in the frequency domain. Generally speaking, there are seven OFDM symbols per slot and thus fourteen OFDM symbols per sub-frame. These resource blocks can be visualised as a grid of “resource elements”, where each resource element is 1/14 ms long and one sub-carrier wide, such that there are eighty-four resource elements per resource block (i.e. seven multiplied by twelve in the case of normal cyclic prefix) and one hundred and sixty-eight resource elements per sub-frame.

Release 13 of the LTE standard introduced coverage enhancement for ‘Bandwidth Reduced Low Complexity’ (BL) and ‘Coverage Enhancement’ (CE) UEs by providing for repetition in physical downlink channels, in particular the physical downlink shared channel (PDSCH) and the MTC physical downlink control channel (MPDCCH).

The repetition of data on these channels is carried out across multiple sub-frames and is designed to provide an averaging gain when the signal power is low, i.e. when the signal-to-noise ratio (SNR) is low. There are two modes of coverage enhancement defined in the standard, ‘Class A’ and ‘Class B’. Class A is a mandatory feature that defines a moderate number of repetitions while Class B is an optional feature that defines a higher number of repetitions. The maximum number of repetitions in Class A is 32 for PDSCH while the maximum number of repetitions in Class B is 2048 for PDSCH.

Similarly, in NB-IoT communications, the narrowband physical downlink shared channel (NPDSCH) may provide for a maximum of 2048 repetitions.

The actual number of repetitions N (e.g. of the PDSCH sub-frames) used is defined by the standard but is typically variable. The number of repetitions being used by the eNB is signalled in the downlink control information (DCI) and is typically selected based on various channel quality metrics, known in the art per se, which will typically vary during operation.

The DCI itself is also typically repeated a number of times by the eNB, where the number of repetitions is network-dependent and may, for example, be set by a scheduler within the network. During the paging process, known in the art per se, a UE will typically try to blindly decode received messages from the network to determine whether there is a DCI message for that UE, or at the very least, for a UE in the same paging group as the UE. The UE has a predefined ‘search space’ in which it looks for such DCI messages. This search space is effectively the collection of the possible locations in which the PDCCH can be located.

The possible locations for the PDCCH differ depending on whether the PDCCH in question is ‘UE-Specific’ or ‘Common’, and also depend on what aggregation level is used, where the aggregation level sets the number of control channel elements (CCE). Each of the possible locations within the search space is called a PDCCH ‘candidate’. Each PDCCH typically carries one DCI and is identified by a radio network temporary identifier (RNTI).

A typical BLJCE UE operating in accordance with the standard is arranged to decode the data symbols repeated across the repeated sub-frames once all of the repetitions have been received, by combining the various repetitions to obtain an improvement in the SNR prior to decoding. However, the Applicant has appreciated that such devices may, in some cases, consume more power than is necessary by operating in this way.

In particular, when a BLJCE UE or non BLJCE UE is supporting the release 13 CE Mode A/CE Mode B, i.e. the above-referenced repetitions, monitoring of the physical downlink control channel (PDCCH) and the reception of data channel with long repetitions may be consuming a significant amount of power, which may be particularly problematic for battery-powered devices, e.g. IoT devices. Blind decoding of the PDCCH is typically required all of the time when configured, even if there is, in fact, no control or data channel transmission for the UE.

### SUMMARY OF THE INVENTION

When viewed from a first aspect, the present invention provides a method of operating a radio receiver device to monitor a paging group over a paging period, said paging group comprising one or more paging candidates wherein each paging candidate has a respective repetition length, wherein the method comprises:
receiving one or more data symbols;
attempting to decode said received data symbols, wherein a successful decoding attempt produces a decoded message comprising a value indicative of a respective repetition length of said decoded message; and
if the decoding attempt is successful, determining that said decoded message is intended for a different paging group and stopping monitoring of at least one of said paging candidates having a respective repetition length greater than said value before the end of the paging period.

This first aspect of the invention extends to a radio receiver device arranged to monitor a paging group over a paging period, said paging group comprising one or more paging candidates wherein each paging candidate has a respective repetition length, wherein the radio receiver device is further arranged to:
receive one or more data symbols;
attempt to decode said received data symbols, wherein a successful decoding attempt produces a decoded message comprising a value indicative of a respective repetition length of said decoded message; and
if the decoding attempt is successful, determine that said decoded message is intended for a different paging group and stop monitoring of at least one of said paging candidates having a respective repetition length greater than said value before the end of the paging period.

This first aspect of the invention also extends to a radio communication system comprising a radio transmitter device arranged to transmit paging messages and a radio receiver device arranged to monitor a paging group over a paging period, said paging group comprising one or more paging candidates wherein each paging candidate has a respective repetition length, the system being arranged such that:
the radio transmitter device transmits one or more data symbols, said data symbols comprising a paging message; and
the radio receiver device is arranged to:
receive the one or more data symbols;
attempt to decode said received data symbols, wherein a successful decoding attempt produces a decoded message comprising a value indicative of a respective repetition length of said decoded message; and
if the decoding attempt is successful, determine that said decoded message is intended for a different paging group and stop monitoring of at least one of said paging candidates having a respective repetition length greater than said value before the end of the paging period.

This first aspect of the invention also extends to a non-transitory computer-readable medium comprising instructions that, when executed by a processor, operate a radio receiver device to monitor a paging group over a paging period, said paging group comprising one or more paging candidates wherein each paging candidate has a respective repetition length, wherein the method comprises:
receiving one or more data symbols;
attempting to decode said received data symbols, wherein a successful decoding attempt produces a decoded message comprising a value indicative of a respective repetition length of said decoded message; and
if the decoding attempt is successful, determine that said decoded message is intended for a different paging group and stopping monitoring of at least one of said paging candidates having a respective repetition length greater than said value before the end of the paging period.

Thus it will be appreciated by those skilled in the art that, unlike the conventional approach, a radio receiver device operated in accordance with embodiments of the present invention may determine that it has successfully decoded a message (e.g. a DCI message) intended for a different paging group which overlaps in time with the candidate being monitored.

This stems from the Applicant having appreciated that, with certain arrangements of the search space used by a given network, it is indeed possible that the radio receiver device may inadvertently decode a message intended for a different paging group which, at least partially, uses the same physical resources as the monitored candidates. The Applicant has furthermore appreciated that such a decoded message having a repetition level shorter than the repetition level of a monitored candidate that overlaps in time with when the device would expect a message intended for its own paging group is indicative that it may be impossible for the network to send messages to that paging group because the physical resources are being used for the other paging group.

Advantageously, a radio receiver device operating in accordance with embodiments of the present invention may detect such a conflict and subsequently decide to cease further monitoring of a candidate within the paging group for the remainder of the paging period.

According to many radio communication protocols, there will be many paging occasions that take place over time, either periodically or non-periodically. At each paging occasion, each paging occasion having a corresponding paging period, the repetition levels being used by the network may vary. Thus, in at least some embodiments, the paging candidate for which monitoring is stopped during a first paging occasion is monitored again during a second paging occasion. In other words, candidates that are discarded during one paging occasion for conflicting in time with another paging group are once again monitored during a subsequent paging occasion because they may not have such a conflict in the subsequent paging occasion.

It will be appreciated that the principles of the present invention may be readily applied to any suitable radio communication system or protocol, however in some embodiments the radio communication device comprises an LTE radio communication device.

In at least some embodiments, the radio communication device comprises an eMTC radio communication device. It will be appreciated that, in accordance with such embodiments, the decoded message may comprise an MTC physical downlink control channel (MPDCCH) message.

Additionally or alternatively, in some embodiments the radio communication device comprises an NB-IoT radio communication device. It will be appreciated that, in accordance with such embodiments, the decoded message may comprise a narrowband physical downlink control channel (NPDCCH) message.

In some embodiments, if the decoding attempt is successful, monitoring of each paging candidate having a respective repetition length greater than said value is stopped before the end of the paging period. For example, if a paging group has candidates of four different repetition levels and a conflict occurs when a decoded message has a value indicating a repetition length less than the repetition levels of three of the candidates in the paging group, monitoring of all three of those candidates may be stopped for the remainder of the paging period.

While the stopping of the monitoring of the candidate(s) having a repetition length longer than that indicated by the decoded message may be carried out immediately, in some embodiments the method comprises:
receiving a further one or more data symbols;
attempting to decode said further one or more received data symbols, wherein a further successful decoding attempt produces a further decoded message comprising a further value indicative of a respective repetition length of said further decoded message; and
if the decoding attempt and the further decoding attempt are both successful, determining that said decoded message is intended for a different paging group and stopping monitoring of at least one of said paging candidates having a respective repetition length greater than said value before the end of the paging period. Thus, in accordance with such embodiments, the radio receiver device may check another repeat to ensure that the first successful decoding attempt that resulted in a believed ‘mismatch’ in repetition length was accurate before ceasing monitoring. While the monitoring may be stopped after one additional repetition, in a set of such embodiments, a plurality of further decoding attempts on subsequent repetitions (i.e. yet further received pluralities of received data symbols) may be carried out before ceasing monitoring.

A further aspect of the invention provides a method of operating a radio receiver device to monitor a paging group over a paging period, said paging group comprising one or more paging candidates wherein each paging candidate has a respective repetition length, wherein the method comprises:
receiving one or more data symbols,
attempting to decode said received data symbols, wherein a successful decoding attempt produces a decoded message comprising a value indicative of a respective repetition length of said decoded message; and
if the decoding attempt is successful, stopping monitoring of a paging candidate having a respective repetition length greater than said value before the end of the paging period.

This aspect further extends to a radio receiver device, radio communication system and non-transitory computer-readable medium.

### BRIEF DESCRIPTION OF DRAWINGS

Certain embodiments of the invention will now be described, by way of example only, with reference to the accompanying drawings in which:

FIG. 1 is a schematic diagram of a radio receiver device;

FIG. 2 is a flowchart illustrating a method of operating the radio receiver device of FIG. 1 in accordance with an embodiment of the present invention;

FIG. 3 is a timing diagram illustrating the method of FIG. 2 ceasing monitoring of a candidate before the end of the paging period;

FIG. 4 is a timing diagram illustrating the method of FIG. 2 ceasing monitoring of all remaining candidates before the end of the paging period;

FIG. 5 is a flowchart illustrating a method of operating the radio receiver device of FIG. 1 in accordance with a further embodiment of the present invention; and

FIG. 6 is a timing diagram illustrating the method of FIG. 5 ceasing monitoring after checking a further repetition.

### DETAILED DESCRIPTION

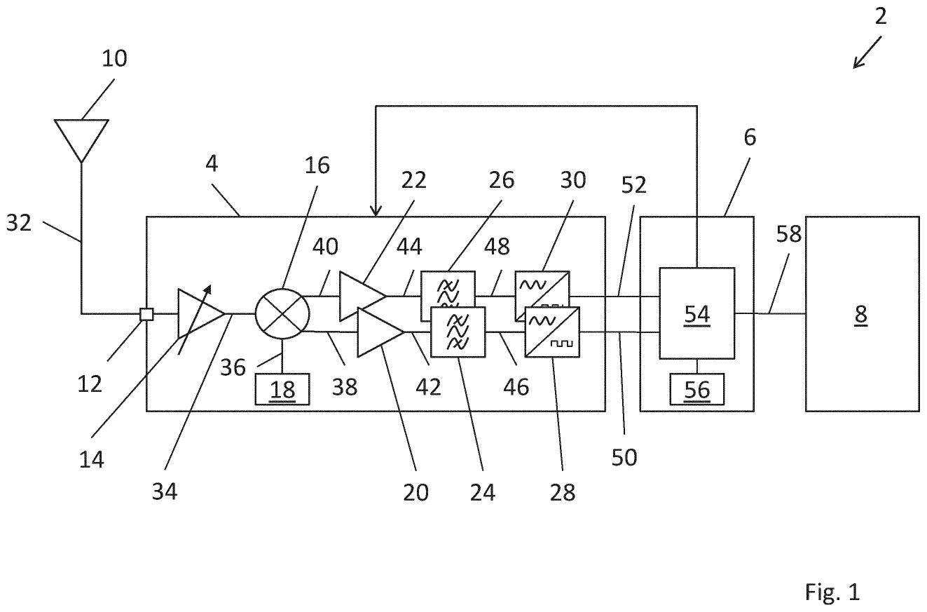

FIG. 1 is a block diagram of an LTE radio receiver device 2 (or User Equipment, ‘UE’ as used interchangeably hereinafter). The receiver 2 is implemented as a system-on-chip (SoC) and comprises: a front-end circuit portion 4; a digital circuit portion 6; and a further circuit portion 8. The structure and operation of each of these circuit portions 4, 6, 8 are described in turn below.

The analogue RF front-end circuit portion 4 is arranged to be connected to an antenna 10 via an antenna terminal 12 for receiving LTE radio signals received over-the-air. The front-end circuit portion 4 comprises: a variable gain pre-amplifier 14; a mixer 16; a local oscillator 18; an in-phase amplifier 20; a quadrature amplifier 22; two bandpass filters 24, 26; an in-phase analogue-to-digital converter (ADC) 28, and a quadrature ADC 30.

When an incoming LTE radio signal 32 is received via the antenna 10, it is first input to the variable gain pre-amplifier 14 which amplifies the signal 32 to a level suitable for processing by downstream circuitry. Typically, the variable gain pre-amplifier 14 is a low-noise amplifier (LNA), a type of amplifier known in the art per se that is particularly suited to amplifying a signal of interest while rejecting unwanted noise.

The resulting amplified signal 34 is input to the mixer 16, which is also arranged to receive a signal 36 generated by the local oscillator 18 as a further input. The signal 36 generated by the local oscillator 18 is set to the frequency of interest (i.e. the carrier frequency associated with the channel to which the receiver 2 is currently tuned). This downmixes the amplified signal 34 to baseband and also splits the signal into an in-phase signal 38 and a quadrature signal 40.

The in-phase signal 38 and the quadrature signal 40 are passed through the in-phase amplifier 20 and the quadrature amplifier 22 respectively to provide further amplification of each of these signals 38, 40. The resulting amplified in-phase signal 42 and amplified quadrature signal 44 are each passed through a respective band-pass filter 24, 26, where the bandpass filters 24, 26 are tuned to reject signals outside a particular frequency range. This results in a filtered in-phase signal 46 and a filtered quadrature signal 48.

The filtered in-phase and quadrature signals 46, 48 are input to the in-phase ADC 28 and the quadrature ADC 30 respectively. These ADCs 28, 30 convert the analogue filtered signals 46, 48 to a digital in-phase signal 50 and a digital quadrature signal 52. The resulting digital signals 50, 52 are then input to the digital circuit portion 6.

The digital circuit portion 6 includes a processor 54 which is connected to a memory 56. The processor is arranged to carry out digital processing of the digital signals 50, 52 in order to decode them, i.e. to retrieve the data within the received sub-frame. The processor 54 may store received sub-frames in the memory 56 for transitional use or for use in subsequent processing. Once the processor 54 decodes the received sub-frame, the resulting data 58 is typically passed to the downstream circuitry 8, which will, under normal operation, use the data, e.g. received DCI messages, for various applications.

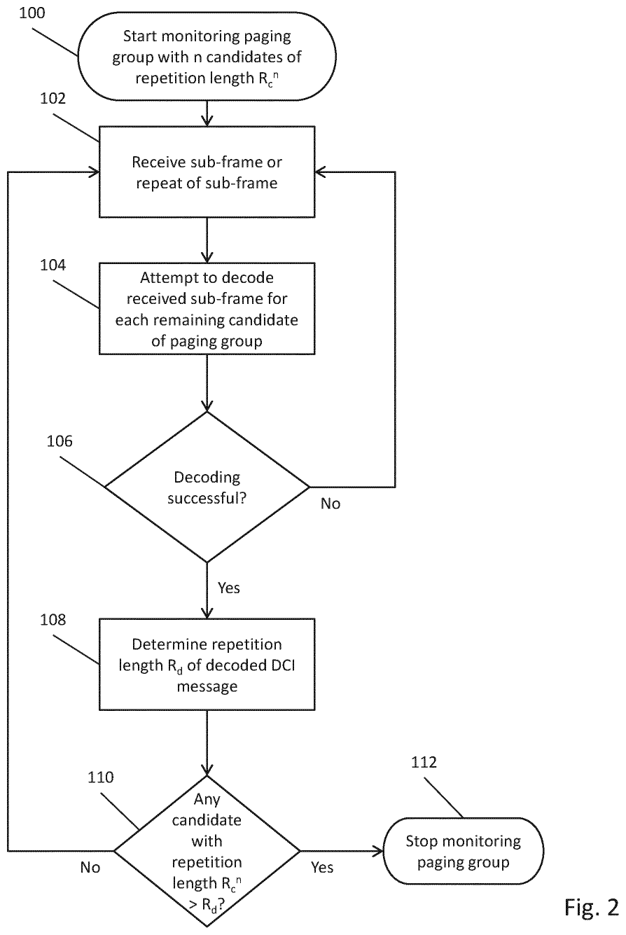

FIG. 2 is a flowchart illustrating a method of operating the LTE radio receiver device 2 or ‘UE’ of FIG. 1 in accordance with an embodiment of the present invention. This flowchart shows the process carried out by the radio receiver device 2 during a single paging occasion.

Initially, at step 100, the radio receiver device 2 wakes at a specific time, known to the device 2, at which the radio receiver device 2 is to check for paging messages from the network. The radio receiver device 2 belongs to a particular ‘paging group’, where a paging group may include one or more other UEs. The network may communicate with many different paging groups, each paging group including one or more UEs to which paging messages may be sent.

This monitoring process, under an LTE-based protocol, involves monitoring for a physical downlink control channel (PDCCH). In the case of eMTC communication this is referred to as MPDCCH while in NB-IoT this is referred to as NPDCCH, as outlined previously.

During this process, the UE 2 monitors a predetermined search space for DCI messages, and in doing so monitors for n different candidates, each having a respective repetition length R_{c}ⁿ. The repetition length in use by the network is not known to the UE 2 a priori, and so the UE 2 must try to ‘blindly decode’ all of the possible candidates on which a DCI message may be validly sent from the network to the paging group of the UE 2.

At step 102, the UE 2 receives an incoming sub-frame constructed from one or more data symbols, where the sub-frame may include a DCI message. The UE 2, at step 104, then attempts to decode the received sub-frame for each of the remaining candidates of the paging group. The processor 54 is arranged to carry out digital processing of the digital signals 50, 52 in order to try and decode them based on an expected format associated with each remaining candidate.

By ‘remaining’, those skilled in the art will understand that this means those candidates having an associated repetition length that is greater than or equal to the total number of repeated sub-frames received thus far. For example, if the paging group consists of four candidates having repetition lengths of two, four, eight, and sixteen sub-frames respectively, by the time the third sub-frame is received, the first of these candidates is no longer remaining because all of the sub-frames that would correspond to that candidate have already been received and processed. For the first iteration of this process, it will be readily understood that all candidates in the paging group are initially ‘remaining’.

At step 106, the UE 2 determines whether the decoding has been successful, i.e. whether the decoding step 104 has successfully resulted in a DCI message, e.g. by determining that the result of the decoding step 104 passes a cyclic redundancy check (CRC).

If, at step 106, the decoding attempt at step 104 is determined not to have been successful, the process returns to step 102 and the UE 2 receives the next repeated sub-frame within the paging period, assuming that the paging period is not complete.

Conversely, if the decoding attempt at step 104 is determined to have been successful, at step 108 the UE 2 determines the repetition length R_{d} of the decoded DCI message, which is typically held as a value within the decoded message. At step 110, the UE 2 compares the repetition length R_{d} of the decoded DCI message to the respective repetition length(s) R_{c}ⁿ of the remaining candidate(s) of the paging group to determine whether there exists any candidate(s) of repetition length R_{c}ⁿ exceeding the indicated repetition length R_{d} of the decoded DCI message.

If there are no candidates of repetition length R_{c}ⁿ exceeding the indicated repetition length R_{d} of the decoded DCI message, the process returns to step 102 and further sub-frames are received, providing the paging period is not complete.

On the other hand, if there are any candidates of respective repetition length R_{c}ⁿ exceeding the indicated repetition length R_{d} of the decoded DCI message, the UE 2 stops monitoring such candidates at step 112 because the UE 2 determines that the DCI message received from the network is destined for another paging group.

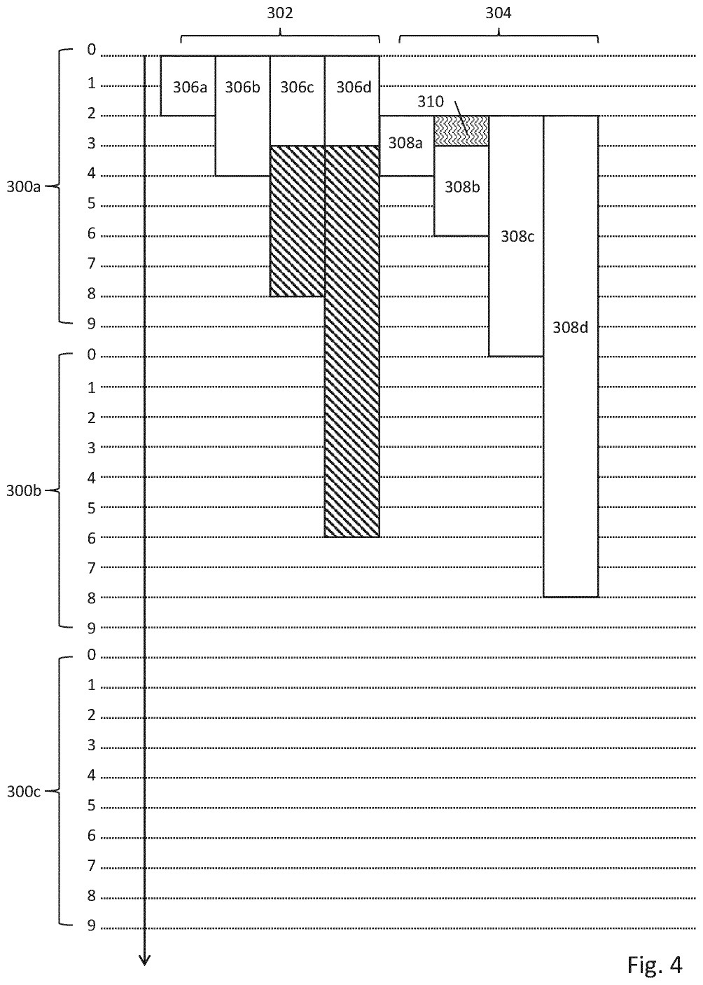

In other words, the UE 2 may detect a conflict when, and only when, the decoded DCI message has an indicated repetition length R_{d} less than the repetition length R_{c}ⁿ of the remaining candidates. If the decoded DCI message does have an indicated repetition length R_{d} less than the repetition length R_{c}ⁿ of all of the remaining candidates, then monitoring of the paging group can be ended. The consequences of the decoded DCI message having an indicated repetition length R_{d} equal to the repetition length R_{c}ⁿ of a remaining candidate are discussed in detail with reference to FIG. 4 below.

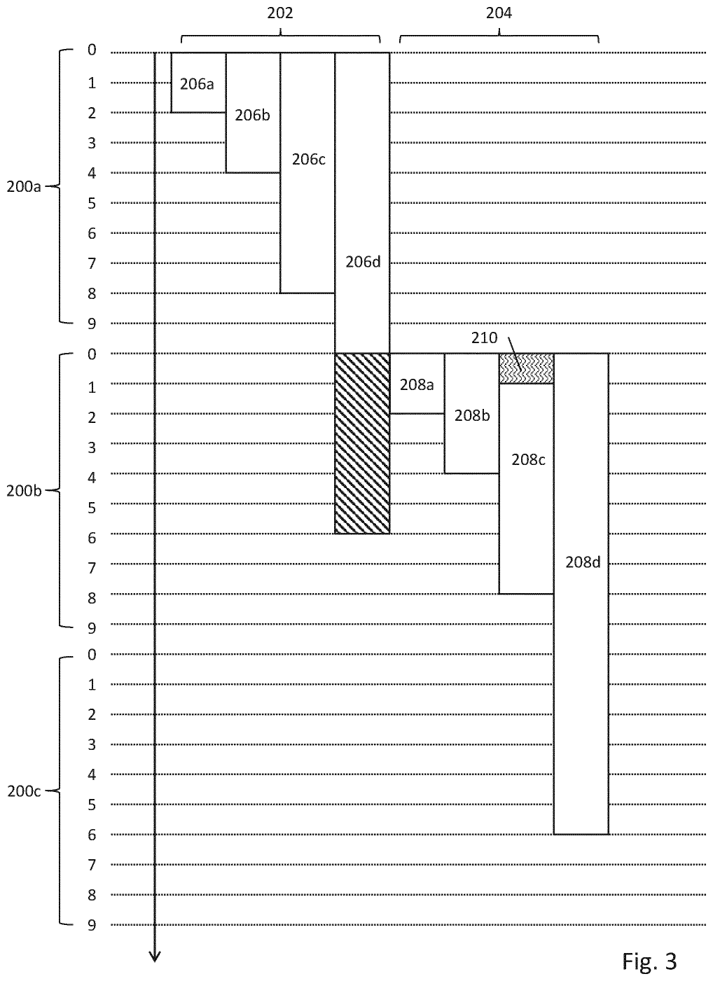

A conflict is determined to exist because the physical resources that would be needed by the network to send a DCI message to the UE 2 via the most recently received sub-frame are already in use to send a DCI message to another paging group. This may be more readily understood with reference to FIGS. 3 and 4, which are described in detail below.

Once a DCI message has been successfully decoded, the UE 2 could receive and decode all subsequent repetitions. However, in order to save power, the UE 2 can stop decoding early and enter a low-power or sleep mode until transmission of the physical downlink shared channel (PDSCH) indicated by the DCI message begins.

FIG. 3 is a timing diagram illustrating the method of FIG. 2 ceasing monitoring of a candidate before the end of the paging period. The timing diagram of FIG. 3 shows three incoming LTE frames 200a-c. Each frame 200a-c is constructed from ten sub-frames, labelled 0-9.

The UE 2 belongs to a first paging group 202, together with one or more other UEs (not shown). Further UEs (not shown) belong to a second paging group 204. The first paging group 202, monitored by the UE 2, contains four candidates 206a-d. Similarly, the second paging group 204, not actively monitored by the UE 2, contains four candidates 208a-d. Each candidate 206a-d, 208a-dhas a different respective repetition length from the other candidates in its paging group.

In the first paging group 202: the first candidate 206a has a repetition length of two sub-frames; the second candidate 206b has a repetition length of four sub-frames; the third candidate 206c has a repetition length of eight sub-frames; and the fourth candidate 206d has a repetition length of sixteen sub-frames.

Similarly, in the second paging group 204: the first candidate 208a has a repetition length of two sub-frames; the second candidate 208b has a repetition length of four sub-frames; the third candidate 208c has a repetition length of eight sub-frames; and the fourth candidate 208d has a repetition length of sixteen sub-frames.

However, it should be appreciated that, while the first and second paging groups 202, 204 have the same number of candidates, this is not necessary and they may differ in practice. Similarly, the respective repetition lengths of the candidates in each paging group 202, 204 need not be matched to one another in practice. There may also be more than just two paging groups.

Over the course of the first frame 200a, attempts are made to decode each candidate 206a-din the first paging group 202 at each received sub-frame (i.e. sub-frames 0 to 9 of the first frame 200a), following the process described above with reference to FIG. 2. However, none of the sub-frames in the first frame 200a leads to a successful decoding of a DCI message. As such, the first three candidates 206a-c of the first paging group 202 are ‘complete’, and are determined to not currently be in use by the network for paging the UE 2 (or any other UE) in the first paging group 202.

While monitoring the fourth candidate 206d of the first paging group 202, the decoding process is determined to be successful at step 106 described above, because a DCI message has resulted from the decoding step 104 during the first sub-frame (sub-frame 0) of the second frame 200b. However, the decoded DCI message indicates that it has a repetition length of eight sub-frames, rather than the expected sixteen sub-frame repetition length associated with DCI messages sent using the fourth candidate 206d.

This is because the decoded DCI message does not correspond to the fourth candidate 206d of the first paging group 202, but instead has arisen because the UE 2 has inadvertently decoded a sub-frame 210 carrying a DCI message on the third candidate 208c of the second paging group 204, i.e. it is intended for a UE in the second paging group 204. This collision is possible due to the structure of the search space.

As the repetition length of the decoded DCI message is less than the repetition length of the fourth candidate 206d of the first paging group, the UE determines that it is impossible for the network to be sending a DCI message to the first paging group 202 on the fourth candidate 206d and so immediately stops monitoring the fourth candidate 206d. In other words, no further decoding attempts are made during the time in which the remaining sub-frames that could contain a DCI message on the fourth candidate 206d of the first paging group 202 are received.

FIG. 4 is a timing diagram illustrating the method of FIG. 2 ceasing monitoring of all remaining candidates before the end of the paging period. During the first two sub-frames, no decoding attempt is successful and the first candidate 306a is determined not to be in use because no decoding was successful during the associated sub-frames—sub-frames 0 and 1 of the first frame 300a .

However, during the third sub-frame (sub-frame 2) of the first frame 300a—while the second, third, and fourth candidates 306b-d are still remaining—the decoding process is determined to be successful at step 106 because a DCI message has resulted from the decoding step 104 during the fourth sub-frame (sub-frame 3) of the first frame 300a. However, the decoded DCI message indicates that it has a repetition length of four sub-frames, rather than the expected eight or sixteen sub-frame repetition length associated with DCI messages sent using the third or fourth candidates 306c, 306d.

Similar to the situation described above with reference to FIG. 3, this is due to the the decoded DCI message not corresponding to any of the second, third, and fourth candidates 306b-d of the first paging group 302, but instead has arisen because the UE 2 has inadvertently decoded a sub-frame 310 carrying a DCI message on the second candidate 308b of the second paging group 304, i.e. it is intended for a UE in the second paging group 304.

The UE 2 then immediately ceases monitoring of the third and fourth candidates 306c, 306d of the first paging group 302 as the respective repetition lengths of these two candidates (at eight and sixteen sub-frames respectively) are greater than the indicated repetition length of the DCI message decoded from the sub-frame 310. However, monitoring of the second candidate 306b continues because it has the same repetition length (i.e. four sub-frames) as the erroneously decoded sub-frame 310 from the second candidate 308b of the second paging group 304.

At this stage, the UE 2 is not currently aware that the erroneously decoded sub-frame 310 is not addressed to the paging group of the UE 2 because the indicated repetition length of the decoded sub-frame 310 matches the repetition length of the second candidate 306b of the first paging group 302, i.e. the paging group 302 that the UE 2 belongs to. In order to determine whether or not the decoded DCI message is intended for the UE 2, the UE 2 must subsequently try to receive the physical downlink shared channel (PDSCH) indicated by the decoded DCI message.

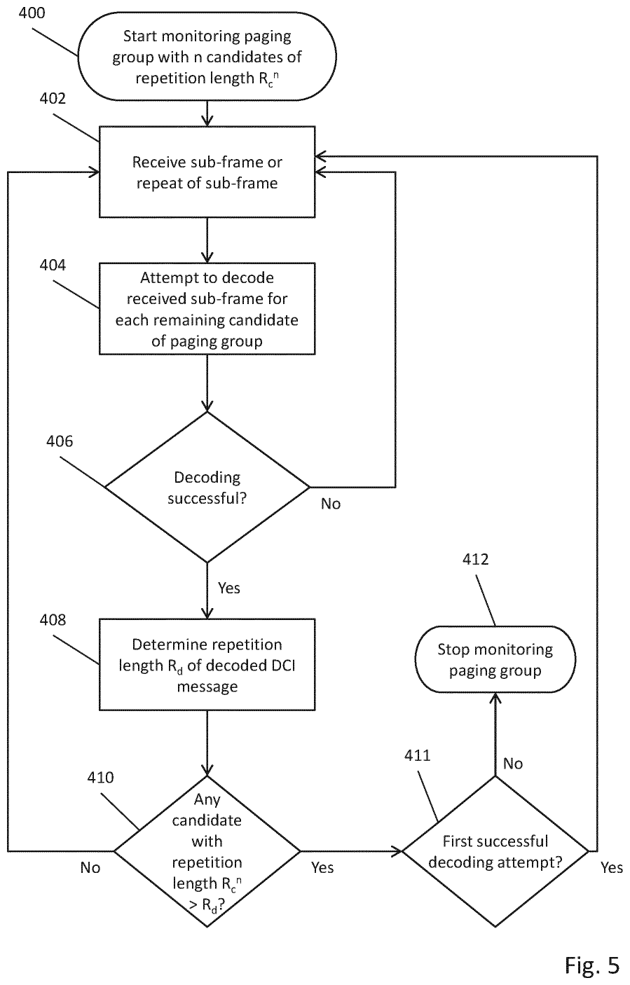

FIG. 5 is a flowchart illustrating a method of operating the LTE radio receiver device 2 or ‘UE’ of FIG. 1 in accordance with a further embodiment of the present invention.

This flowchart shows the process carried out by the radio receiver device 2 during a single paging occasion.

Similar to the process described with reference to FIG. 2, at step 400, the radio receiver device 2 wakes at a specific time, known to the UE 2 in advance, to check for paging messages from the network. During this process, the UE 2 monitors a predetermined search space for DCI messages, and in doing so monitors for n different candidates, each having a respective repetition length R_{c}ⁿ. The repetition length in use by the network is not known to the UE 2 a priori, and so the UE 2 must try to ‘blindly decode’ all of the possible candidates on which a DCI message may be validly sent from the network to the paging group of the UE 2.

At step 402, the UE 2 receives an incoming sub-frame constructed from one or more data symbols, where the sub-frame may include a DCI message. The UE 2, at step 404, then attempts to decode the received sub-frame for each of the remaining candidates of the paging group. The processor 54 is arranged to carry out digital processing of the digital signals 50, 52 in order to try and decode them based on the expected format associated with each remaining candidate.

At step 406, the UE 2 determines whether the decoding has been successful, i.e. whether the decoding step 404 has successfully resulted in a DCI message, e.g. by determining that the result of the decoding step 404 passes a CRC process.

If, at step 406, the decoding attempt at step 404 is determined not to have been successful, the process returns to step 402 and the UE 2 receives the next repeated sub-frame within the paging period, assuming that the paging period is not complete.

Conversely, if the decoding attempt at step 404 is determined to have been successful, at step 408 the UE 2 determines the repetition length R_{d} of the decoded

DCI message, which is typically held as a value within the decoded message. At step 410, the UE 2 compares the repetition length R_{d} of the decoded DCI message to the respective repetition length(s) R_{c}ⁿ of the remaining candidate(s) of the paging group to determine whether there exists any candidate(s) of repetition length R_{c}ⁿ exceeding the indicated repetition length R_{d} of the decoded DCI message.

If there are no candidates of repetition length R_{c}ⁿ exceeding the indicated repetition length R_{d} of the decoded DCI message, the process returns to step 402 and further sub-frames are received, providing the paging period is not complete.

On the other hand, if there are any candidates of respective repetition length R_{c}ⁿ exceeding the indicated repetition length R_{d} of the decoded DCI message, at step 411 the UE 2 checks whether the erroneously decoded DCI message is the first such successful decoding.

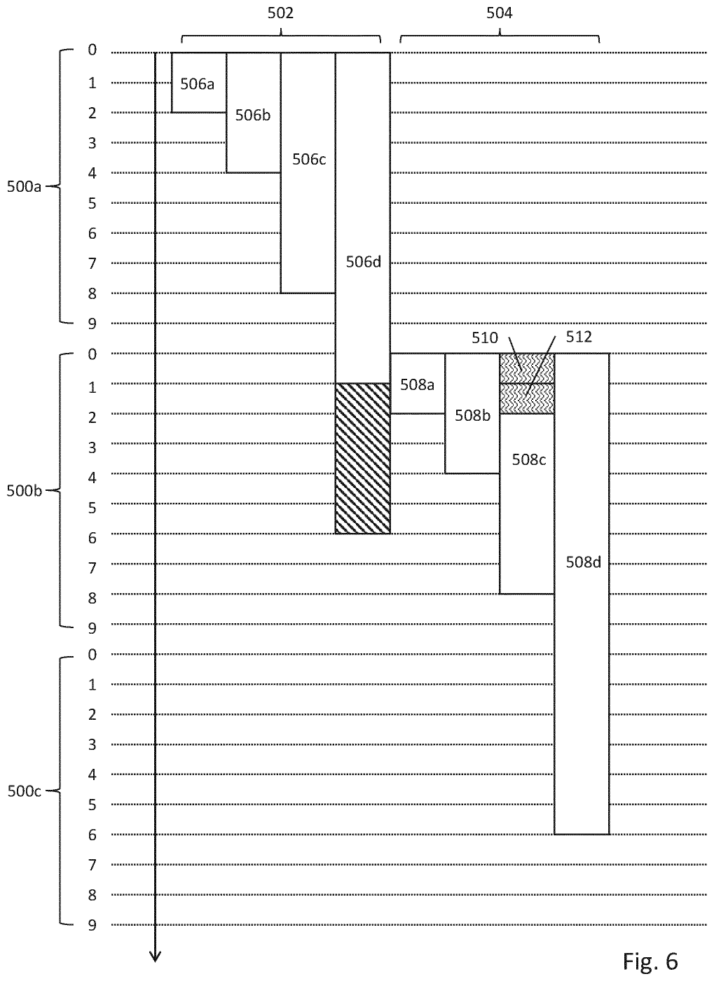

If at step 411 the UE 2 determines that this DCI message has been erroneously decoded for the first time, the process returns to step 402 and a further sub-frame is received and checked. If, however, the DCI message intended for a different paging group is successfully decoded a second time, then the decision is taken at step 411 to stop monitoring those candidates having a respective repetition length R_{c}ⁿ exceeding the indicated repetition length R_{d} of the decoded DCI message at step 412. A worked example of this process is described below with reference to FIG. 6.

FIG. 6 is a timing diagram illustrating the method of FIG. 5 ceasing monitoring after checking a further repetition. Similarly to FIGS. 3 and 4, the timing diagram of FIG. 6 shows three incoming LTE frames 500a-c. Each frame 500a-c is constructed from ten sub-frames, labelled 0-9.

The UE 2 belongs to a first paging group 502, together with one or more other UEs (not shown). Further UEs (not shown) belong to a second paging group 504. The first paging group 502, monitored by the UE 2, contains four candidates 506a-d. Similarly, the second paging group 504, not actively monitored by the UE 2, contains four candidates 508a-d. Each candidate 506a-d, 508a-dhas a respective repetition length.

In the first paging group 502: the first candidate 506a has a repetition length of two sub-frames; the second candidate 506b has a repetition length of four sub-frames; the third candidate 506c has a repetition length of eight sub-frames; and the fourth candidate 506d has a repetition length of sixteen sub-frames.

Similarly, in the second paging group 504: the first candidate 508a has a repetition length of two sub-frames; the second candidate 508b has a repetition length of four sub-frames; the third candidate 508c has a repetition length of eight sub-frames; and the fourth candidate 508d has a repetition length of sixteen sub-frames. However, it should be appreciated that, while the first and second paging groups 502, 504 have the same number of candidates, this is not necessary and they may differ in practice. Similarly, the respective repetition lengths of the candidates in each paging group 502, 504 need not be matched to one another in practice. There may also be more than just two paging groups.

Over the course of the first frame 500a, attempts are made to decode each candidate 506a-din the first paging group 502 at each received sub-frame (i.e. sub-frames 0 to 9 of the first frame 500a), following the process described above with reference to FIG. 2. However, none of the sub-frames in the first frame 500a leads to a successful decoding of a DCI message. As such, the first three candidates 506a-c of the first paging group 502 are ‘complete’, and are determined to not currently be in use by the network for paging the UE 2 (or any other UE) in the first paging group 502.

While monitoring the fourth candidate 506d of the first paging group 502, the decoding process is determined to be successful at step 406 described above as a DCI message has resulted from the decoding step 404 during the first sub-frame (sub-frame 0) of the second frame 500b. However, the decoded DCI message indicates that it has a repetition length of eight sub-frames, rather than the expected sixteen sub-frame repetition length associated with DCI messages sent using the fourth candidate 506d.

This is because the decoded DCI message does not correspond to the fourth candidate 506d of the first paging group 502, but instead has arisen because the UE 2 has inadvertently decoded a sub-frame 510 carrying a DCI message on the third candidate 508c of the second paging group 504, i.e. it is intended for a UE in the second paging group 504.

However, rather than immediately ceasing monitoring of the fourth candidate 506d of the first paging group 502, the UE 2 receives a further sub-frame 512 (sub-frame 1 of the second frame 500b) to determine whether the erroneously decoded DCI message was spurious or whether the UE 2 is indeed decoding a DCI message intended for the second paging group 504.

However, this second sub-frame 512 is also decoded successfully by the UE 2 and thus because the UE 2 has managed to successfully decode a DCI message having indicating a shorter repetition length than the repetition length of the fourth candidate 506d, the UE 2 decides at that point in time to cease monitoring the fourth candidate 506d. It will be appreciated that while one further sub-frame is used to check for spurious decoding errors, more repetitions could be checked, albeit at the expense of additional power consumption if the UE 2 could have stopped monitoring the channel sooner.

Thus it will be appreciated by those skilled in the art that embodiments of the present invention provide an improved radio receiver device that may determine whether there are any incoming signals destined for the device and, if not, ignore incoming signals and/or go to sleep, which may advantageously result in reduced power consumption compared to conventional radio receiver devices. It will be appreciated by those skilled in the art that the embodiments described above are merely exemplary and are not limiting on the scope of the invention.

1. A method of operating a radio receiver device to monitor a paging group over a paging period, said paging group comprising one or more paging candidates wherein each paging candidate has a respective repetition length, wherein the method comprises:
receiving one or more data symbols;
attempting to decode said received data symbols, wherein a successful decoding attempt produces a decoded message comprising a value indicative of a respective repetition length of said decoded message; and
if the decoding attempt is successful, determining that said decoded message is intended for a different paging group and stopping monitoring of at least one of said paging candidates having a respective repetition length greater than said value before the end of the paging period.

2. The method as claimed in claim 1, further comprising monitoring the paging candidate, for which monitoring was stopped during a first paging occasion, again during a second paging occasion.

3. The method as claimed in claim 1, wherein the radio communication device comprises an LTE radio communication device.

4. The method as claimed in claim 3, wherein the radio communication device comprises an eMTC radio communication device, optionally wherein the decoded message comprises an MTC physical downlink control channel (MPDCCH) message.

5. The method as claimed in claim 3, wherein the radio communication device comprises an NB-IoT radio communication device, optionally wherein the decoded message comprises a narrowband physical downlink control channel (NPDCCH) message.

6. The method as claimed in claim 1, further comprising stopping monitoring of each paging candidate having a respective repetition length greater than said value before the end of the paging period if the decoding attempt is successful.

7. The method as claimed in claim 1, further comprising:
receiving a further one or more data symbols;
attempting to decode said further one or more received data symbols, wherein a further successful decoding attempt produces a further decoded message comprising a further value indicative of a respective repetition length of said further decoded message; and
if the decoding attempt and the further decoding attempt are both successful, determining that said decoded message is intended for a different paging group and stopping monitoring of at least one of said paging candidates having a respective repetition length greater than said value before the end of the paging period.

8. The method as claimed in claim 7, comprising carrying out a plurality of further decoding attempts on at least one yet further received plurality of received data symbols before monitoring of the paging candidate(s) is stopped.

9. A radio receiver device arranged to monitor a paging group over a paging period, said paging group comprising one or more paging candidates wherein each paging candidate has a respective repetition length, wherein the radio receiver device is further arranged to:
receive one or more data symbols;
attempt to decode said received data symbols, wherein a successful decoding attempt produces a decoded message comprising a value indicative of a respective repetition length of said decoded message; and
if the decoding attempt is successful, determine that said decoded message is intended for a different paging group and stop monitoring of at least one of said paging candidates having a respective repetition length greater than said value before the end of the paging period.

10. The radio receiver device as claimed in claim 9, further arranged to monitor the paging candidate, for which monitoring was stopped during a first paging occasion, again during a second paging occasion.

11. The radio receiver device as claimed in claim 9, comprising an LTE radio communication device.

12. The radio receiver device as claimed in claim 11, comprising an eMTC radio communication device, optionally wherein the decoded message comprises an MTC physical downlink control channel (MPDCCH) message.

13. The radio receiver device as claimed in claim 11, comprising an NB-IoT radio communication device, optionally wherein the decoded message comprises a narrowband physical downlink control channel (NPDCCH) message.

14. The radio receiver device as claimed in claim 9, further arranged to stop monitoring of each paging candidate having a respective repetition length greater than said value before the end of the paging period if the decoding attempt is successful.

15. The radio receiver device as claimed in claim 9, further arranged to:
receive a further one or more data symbols;
attempt to decode said further one or more received data symbols, wherein a further successful decoding attempt produces a further decoded message comprising a further value indicative of a respective repetition length of said further decoded message; and
if the decoding attempt and the further decoding attempt are both successful, determine that said decoded message is intended for a different paging group and stop monitoring of at least one of said paging candidates having a respective repetition length greater than said value before the end of the paging period.

16. The radio receiver device as claimed in claim 15, arranged to carry out a plurality of further decoding attempts on at least one yet further received plurality of received data symbols before monitoring of the paging candidate(s) is stopped.

17. A radio communication system comprising a radio transmitter device arranged to transmit paging messages and a radio receiver device arranged to monitor a paging group over a paging period, said paging group comprising one or more paging candidates wherein each paging candidate has a respective repetition length, the system being arranged such that:
the radio transmitter device transmits one or more data symbols, said data symbols comprising a paging message; and
the radio receiver device is arranged to:
receive the one or more data symbols;
attempt to decode said received data symbols, wherein a successful decoding attempt produces a decoded message comprising a value indicative of a respective repetition length of said decoded message; and
if the decoding attempt is successful, determine that said decoded message is intended for a different paging group and stop monitoring of at least one of said paging candidates having a respective repetition length greater than said value before the end of the paging period.

18. A non-transitory computer-readable medium comprising instructions that, when executed by a processor, operate a radio receiver device to monitor a paging group over a paging period, said paging group comprising one or more paging candidates wherein each paging candidate has a respective repetition length, wherein the method comprises:
receiving one or more data symbols;
attempting to decode said received data symbols, wherein a successful decoding attempt produces a decoded message comprising a value indicative of a respective repetition length of said decoded message; and
if the decoding attempt is successful, determine that said decoded message is intended for a different paging group and stopping monitoring of at least one of said paging candidates having a respective repetition length greater than said value before the end of the paging period.
